(19) United States
(12) Patent Application Publication
(10) Pub. No.: US 2011/0022453 A1
(43) Pub. Date: Jan. 27, 2011

(54) SYSTEM AND METHOD FOR PROVIDING RULES-BASED MEDIA BUNDLES

(75) Inventor: Rajiv Dutta, Saratoga, CA (US)

Correspondence Address: SCHWEGMAN, LUNDBERG & WOESSNER, P.A., P.O. BOX 2938, MINNEAPOLIS, MN, 55402, US

(73) Assignee: Tokoni Inc., Cupertino, CA (US)

(21) Appl. No.: 12/510,039

(22) Filed: Jul. 27, 2009

(51) Int. Cl. G06Q 30/00; G06Q 50/00

(52) U.S. Cl. 705/14.25; 705/26.25

(57) ABSTRACT

In various exemplary embodiments, a system and associated method to provide rule-based media subscription bundles is provided. A selection of a subscription plan is received from a subscriber. One or more content categories and rules associated with the selected subscription plan are determined. The rules comprise a designation of a number of selections of media to be made from the one or more content categories. A listing of media associated with the one or more content categories is provided to the subscriber, and a selection of media from the listing of media is received in response. The media subscription bundle comprising the selected media is then generated.

### TECHNICAL FIELD

The present application relates generally to the field of computer technology and, in a specific exemplary embodiment, to a system and method for providing rules-based media bundles.

### BACKGROUND

Conventionally, subscribers subscribe to a number of media types and forms separately and independently. For example, a subscriber may separately subscribe to a local newspaper and two national magazines.

For television, multiple channels may be bundled together for subscription (e.g., cable services). However, the subscriber does not have the ability to select individual programs, series, or channels for their subscription bundle. The subscriber typically will have to subscribe to a pre-bundled package of content, even if the subscriber only wants a few of the channels or only one series or program.

In other conventional subscriptions, a subscriber may select some of the media to which they want to subscribe (e.g., one or more premium cable channels), however, it is a manual process. For example, the subscriber will need to communicate with a sales representative of various media to indicate which of the media the subscriber desires. The sales representative then must manually determine if the selected media may be bundled together and the price for the resulting bundle. This can be a time consuming process and may discourage a potential subscriber from subscribing to the media. Further, a subscriber does not have the ability to make an ad-hoc purchase of a single issue of a newspaper or magazine online and bill it to their online account.

### BRIEF DESCRIPTION OF DRAWINGS

Various ones of the appended drawings merely illustrate exemplary embodiments of the present invention and cannot be considered as limiting its scope.

FIG. 1 is a block diagram illustrating an exemplary embodiment of a high-level, client-server-based network architecture of a system used to provide rules-based media bundles.

FIG. 2 is a block diagram illustrating an exemplary embodiment of an aggregated media system of the network architecture of FIG. 1.

FIG. 3 is a block diagram illustrating an exemplary embodiment of systems of the aggregated media system of FIG. 2.

FIG. 4 is a block diagram illustrating an exemplary embodiment of an account system.

FIG. 5 is a block diagram illustrating an exemplary embodiment of a content acquisition system.

FIG. 6 is a block diagram illustrating an exemplary embodiment of a content distribution system.

FIG. 7 is a block diagram illustrating an exemplary embodiment of a tracking system.

FIG. 8 is a flowchart illustrating an exemplary method for establishing subscription plans.

FIG. 9 is a flowchart illustrating an exemplary method for generating a media subscription bundle.

FIG. 10 is a simplified block diagram of a machine in an exemplary form of a computing system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody the present inventive subject matter. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Each of a variety of exemplary embodiments is discussed in detail, below.

Exemplary embodiments provide systems and methods for providing rules-based media bundles. By utilizing rules in conjunction with categories to which media is associated with, a subscriber may easily customize a media subscription bundle comprising only media desired by the subscriber in an efficient and automated manner.

In exemplary embodiments, a selection of a subscription plan is received from a subscriber. Based on the selected subscription plan, one or more content categories and rules associated with the selected subscription plan are determined. The rules comprise a designation of a number of selections of media to be made from the one or more content categories. For example, the rules for one subscription plan may allow selection of one national newspaper, two local newspapers, and two online journals. A listing of media associated with the one or more content categories is then provided. Continuing with the example, a listing of national newspapers, local newspapers, online journals and television programs are provided. A selection of media from the listing of media is then received from the subscriber. The media subscription bundle comprising the selected media is then generated for the subscriber.

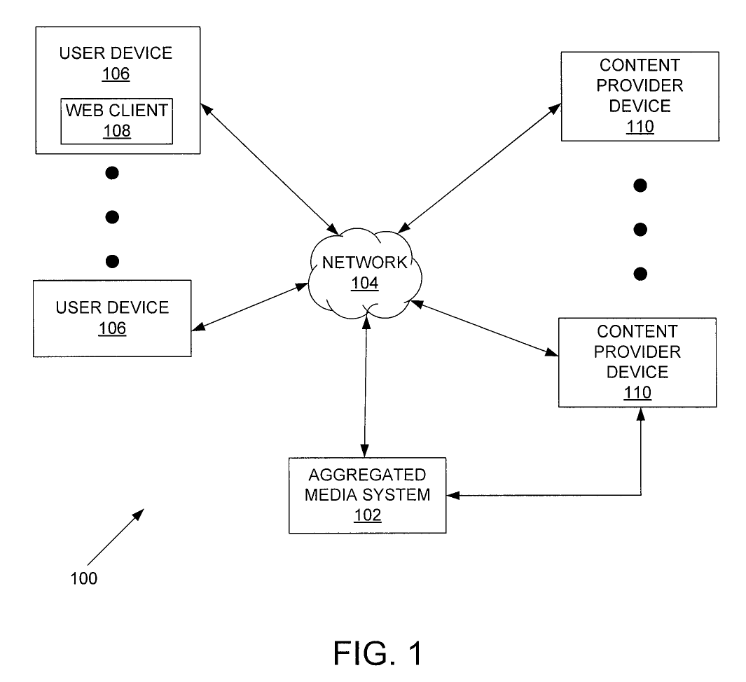

With reference to FIG. 1, an exemplary embodiment of a high-level client-server-based network architecture 100 for providing rules-based media bundles is shown. An aggregated media system 102 is coupled via a network 104 (e.g., the Internet or Wide Area Network (WAN)) to one or more user devices 106. The aggregated media system 102 manages the subscriptions for media. In exemplary embodiments, the aggregated media system 102 generates subscription plans that allow the subscribers to customize their own bundle of media content. The various systems and processes that allow the customized rules-based media bundles will be discuss in more detail herein.

Media comprises any content with which a respective subscriber may want to interact. Examples of media content include, but are not limited to, video (e.g., movies, television shows or series, premium video channels such as HBO), print (e.g., newspaper, magazines, journals, books), and online content (e.g., electronic documents) that a subscriber may wish to consume (e.g., view or read).

The user devices 106 are used to access subscribed-to media content via the network 104. FIG. 1 illustrates, for example, a web client 108 operating via a browser (e.g., such as the Internet Explorer® browser) on one of the user devices 106. The user device 106 may comprise a mobile or handheld device (e.g., cellular phone, laptop, offline reader device), desktop device (e.g., desktop computer), or any device that can communicate over the network 104 to access media. Each subscriber may have more than one user device 106 associated with them. For example, the subscriber may have a cellular phone, a laptop, set-top box, and an e-book reader. This subscriber may access media content via any of these user devices 106.

The media content is provided from multiple content providers. In some embodiments, the media content is provided from content provider devices 110. In one embodiment, the media content is provided via the network 104 to the aggregated media system 102 for distribution to subscribers. In another embodiment, the media content is directly provided to subscribers at their user device 106 from the content provider device 110. Furthermore, the media content may be provided directly to the aggregated media system 102 from the content provider or content provider device 110 (e.g., physically provided to the aggregated media system 102 without the use of the network 104).

While the exemplary architecture 100 of FIG. 1 employs a client-server architecture, a skilled artisan will recognize that the present disclosure is not limited to such an architecture. The exemplary architecture 100 can equally well find application in, for example, a distributed or peer-to-peer architecture system. The aggregated media system 102 may also be implemented as standalone systems or standalone software programs operating under a separate hardware platform.

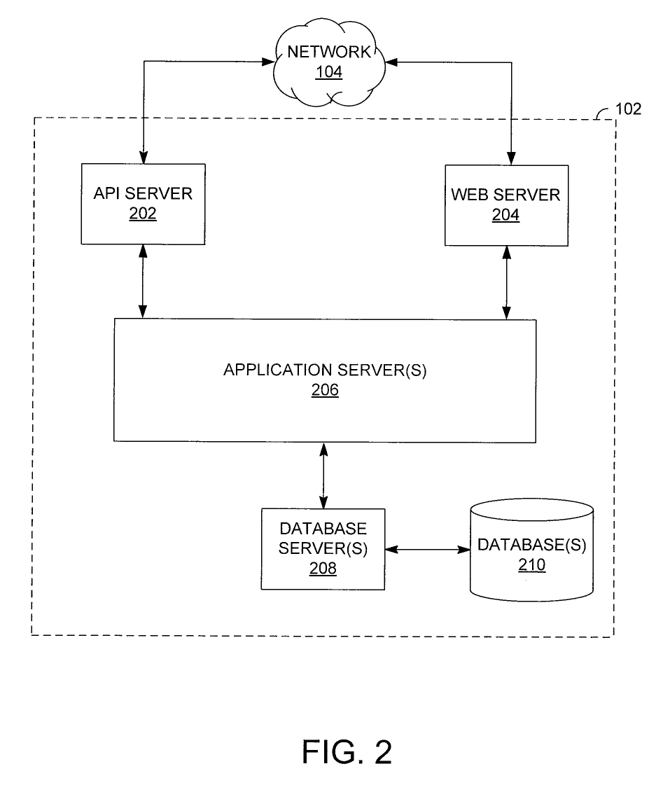

FIG. 2 is a block diagram illustrating an exemplary embodiment of the aggregated media system 102 of the network architecture of FIG. 1. As illustrated, an Application Program Interface (API) server 202 and a web server 204 are coupled to, and provide programmatic and web interfaces respectively to, one or more application servers 206 of the aggregated media system 102. The application servers 206 host a plurality of systems, which may comprise one or more modules, applications, or engines, each of which may be embodied as hardware, software, firmware, or any combination thereof.

The application servers 206 are, in turn, coupled to one or more database servers 208 facilitating access to one or more database(s) 210. The databases 210 may store subscription account information. The databases 210 may also store media content provided by the content providers. The media content includes electronic copies of print media (e.g., newspaper, magazines), video (e.g., television series or programs), and online media (e.g., online journals, online newspaper). Virtually any content that a subscriber may be interested in obtaining may be provided as media content.

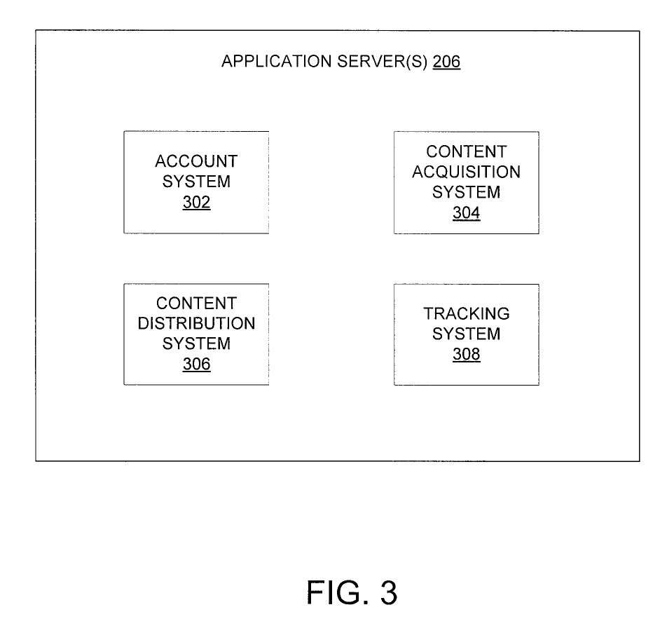

FIG. 3 is a block diagram illustrating exemplary systems of the one or more application servers 206 of the aggregated media system 102. The systems comprise an account system 302, a content acquisition system 304, a content distribution system 306, and a tracking system 308. The account system 302 manages user and content provider accounts, as well as subscription plans and media bundles. The content acquisition system 304 manages the acquisition of media content from various content providers, while the content distribution system 306 manages distribution of the media content. The tracking system 308 manages the tracking of user activities with respect to the media both online and offline. Each of these systems will be discussed in more detail below.

It should be noted that the systems of FIG. 3 are exemplary. Alternative embodiments may comprise more, less, or functionally equivalent (but differently named or combined) systems.

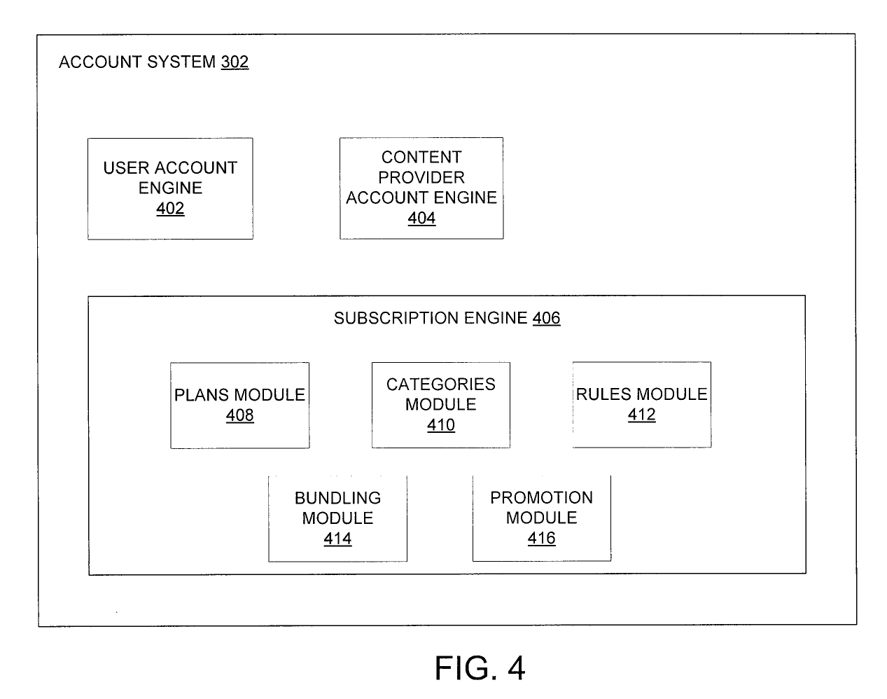

FIG. 4 is a block diagram illustrating an exemplary embodiment of an account system (e.g., the account system 302). The account system 302 manages user and content provider accounts, as well as subscription plans and media bundles The account system 302 comprises a user account engine 402, a content provider account engine 404, and a subscription engine 406. The user account engine 402 handles subscriber accounts. In exemplary embodiments, the user account engine 402 establishes a user account for each subscriber and maintains account information for each user account. The account information includes, for example, subscriber's identity, contact information, billing and payment information, online access information (e.g., user names and passwords), and information about one or more media bundles associated with each subscriber.

The content provider account engine 404 handles content provider accounts. In exemplary embodiments, accounts are established for content providers that provide content to the aggregated media system. These content providers may be provided revenue in exchange for providing content or access to content. By maintain content provider accounts, the management of revenues may be easily managed. It is noted that content providers need not have an account established with the aggregated media system in order to provide media content.

The subscription engine 406 manages subscriptions and allows for the generation of media bundles. When a subscriber subscribes to the aggregated media system, the subscriber is presented with a plurality of subscription plans. These subscription plans are established based on rules and categories by a plans module 408. For example, a basic subscription plan may allow a subscriber to subscribe to a national newspaper, three local newspapers, one sports magazine, and one men's interest magazine, whereas another subscription plan (e.g., a sports subscription plan) allows a subscriber to subscribe to three sports magazines, two sports sections from newspapers, and two television programs from one sports channel. Furthermore, the subscription plan may allow an ad-hoc purchase of a single issue of a newspaper or magazine online which may be billed to the subscriber's online account.

The rules associated with the selected subscription plan may include a time component. For example, a subscription plan may allow a subscription to a media component for one day, one week, one month, or any other period of time.

In some embodiments, the plans module 408 may generate subscription plans based on user inputs. For example, the subscriber may indicate an interest area and number of media to which the subscriber desires to subscribe. The plans module 408 may customize a subscription plan to the subscribers and determine a subscription price. As such, an infinite number of subscription plans may be available to the subscriber.

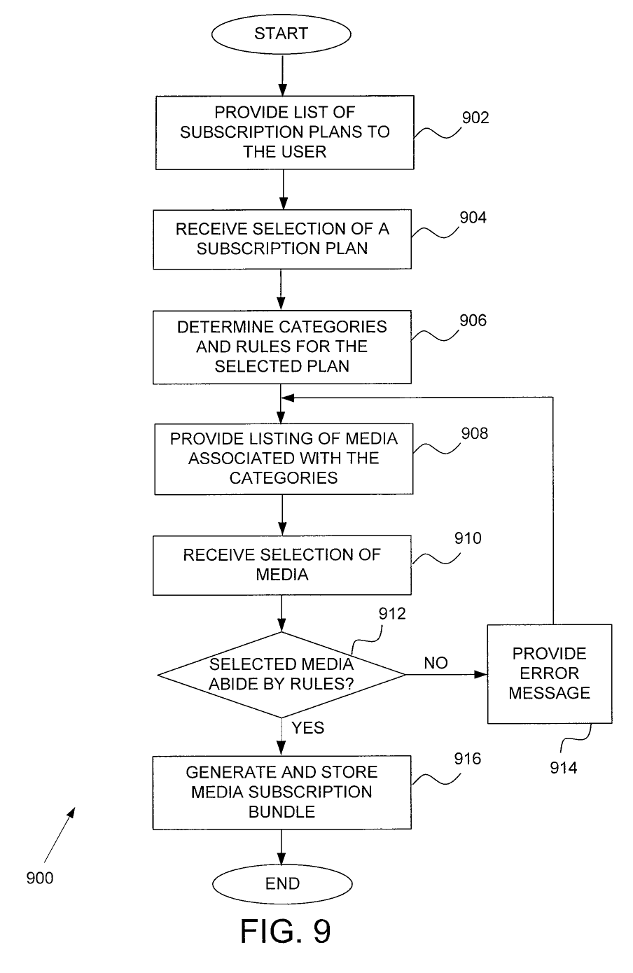

In exemplary embodiments, media and media components (e.g., a single article, section, or episode of a media) are categorized into one or more content categories established by the aggregated media system by a categories module 410. Content categories include, for example, newspapers, magazines, journals, television series, television program (e.g., a single instance of a show or a one-time event), online newspapers, online magazines, and online video series. The content categories are further divided into global, national, regional, and local categories. Thus, a media may be categorized under multiple content categories. For example, The New York Times may be categorized as a national, regional (e.g., to the East Coast), and local (e.g., to New York) newspaper, while an online version of The New York Times may be categorized as a national, regional, and local online newspaper. Furthermore, sections of the New York Times may be categorized as well. For example, a sports section of the New York Times may be categorized under a sports category, a local sports category, a regional sports category, and a national sports category. The categories module 410 manages the categorization of each media and media component. In a video example, the content categories may also include sub-categories. So in a television analogy, the subscriber may subscribe to a channel (e.g., HBO), a series (e.g., Six Feet Under), or a specific episode or program (e.g., Tyson fight). The categories module 410 further provides the categories to a subscriber when the subscriber is customizing their media bundle as will be discussed in more detail in connection with FIG. 9.

A rules module 412 ensures that a subscriber conforms to the rules associated with a selected subscription plan when establishing their customized media bundle. Continuing with the basic subscription plan example, the rules module 412 checks that a subscriber's selection of media includes one national newspaper, three local newspapers, one sports magazine, and one men's interest magazine. If the selection does not conform with these rules, then an error message is sent to the subscriber, and the subscriber is required to adjust their selection until a conforming set of media is selected. Alternatively, the subscriber may be asked if they want to change their subscription plan to a subscription plan with rules that conform with the selected media.

Once the selection conforms with the rules of the selected subscription plan, a bundling module 414 establishes a customized (rules-based) bundle for the subscriber. Data associated with the customized bundle will be associated with the subscriber's account, and the subscriber will have access to the selected media of the customized bundle.

A promotion module 416 incorporates promotions from a content provider into the selected subscription plan. Because the media content is generally paid-for content, promotions currently offered by the content provider are integrated into the subscription plan. For example if The New York Times is offering the first three months free, this promotion is integrated into the selected subscription plan (e.g., a reduction in subscription price).

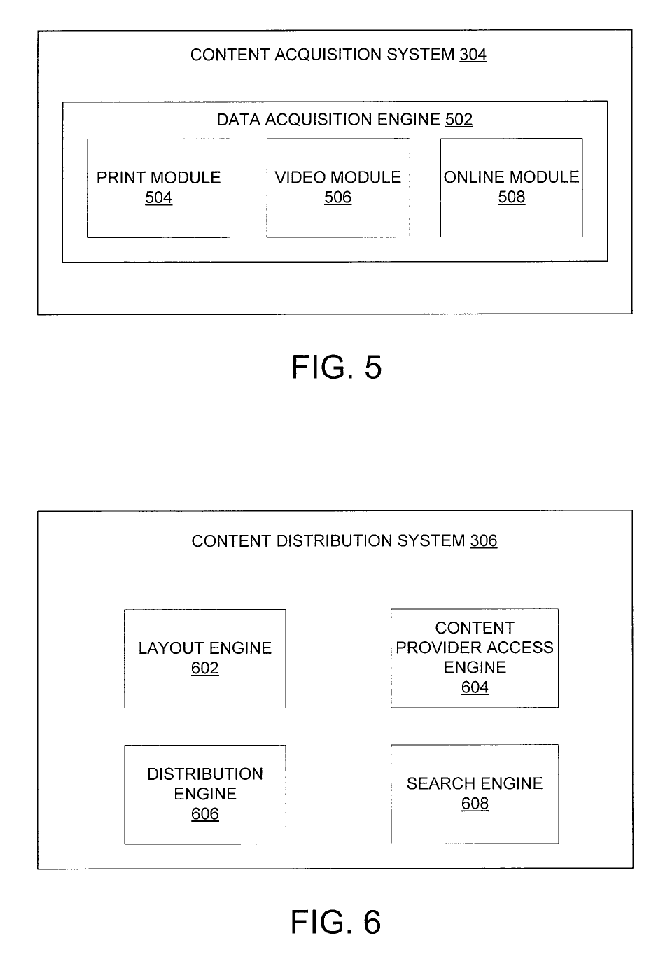

FIG. 5 is a block diagram illustrating an exemplary embodiment of a content acquisition system 304. The content acquisition system 304 comprises a data acquisition engine 502 including a print module 504, a video module 506, and an online module 508. Other modules may be provided in the data acquisition engine 502 to accommodate other forms of media content. Each of the modules 504, 506, and 508 obtains their respective media content for distribution to subscribers. The obtained media content may be stored in one or more databases (e.g., the database 210).

Because media comes from various sources, different modules are used to obtain media content. For example, the print module 504 is configured to obtain print content in various forms, such as a PDF version or a reformatted digital version of the print content. The video module 506 may be configured, for example, to receive streaming data representing a video program or receive digital television transmissions. The online module 508 receives web-based content. The web-based content may be streamed to the aggregated media system for storage in a database (e.g., the database 210). Alternatively, links to the web-based content at the content provider device 110 may be maintained by the aggregated media system.

In some embodiments, the acquired media content may comprise layout metadata. For example, the metadata may be associated with the News Industry Text Format or PDF. In other embodiments, a publisher template may be associated with the acquired media content. The publisher templates provide layout rules and style information which cover various portions of the media content (e.g., story hierarchy, adjacency, advertising, front page, internal pages, spreads).

FIG. 6 is a block diagram illustrating an exemplary embodiment of a content distribution system (e.g., the content distribution system 306). The content distribution system 306 comprises a layout engine 602, a content provider access engine 604, a distribution engine 606, and a search engine 608.

The layout engine 602 formats media content from the aggregated media system into a form that will be viewable on a specific user device of the subscriber receiving the media content. In some embodiments, the media content may comprise layout metadata. In these embodiments, the layout engine 602 formats the media content in a preferred or indicated format based on the metadata (e.g., News Industry Text Format, PDF). In other embodiments, a publisher template may be utilized by the layout engine 602. The publisher template, as well as the metadata, provides layout rules and style information which cover various portions of the media content (e.g., front page, internal pages, spreads). The layout rules and style are combined with information regarding a display device (e.g., the user device 106) associated with the subscriber to format the media content. The formatted media content may comprise, for example, flowable text or columns, HTML, and print. The layout engine 602 further formats advertising from print editions to digital editions for display (e.g., with the subscribed-to media).

The content provider access engine 604 provides access to media content from the content provider (e.g., via the content provider device 110). In exemplary embodiments, when the subscriber is logged into their account with a particular content provider, the content provider access engine 604 also allows access to media content from the particular content provider via the aggregated media system without having to log in with the aggregated media system. Alternatively, when the subscriber is logged into the aggregated media system, the subscriber may access the media content directly from the content provider without having to log in with the content provider. In yet other embodiments, the aggregated media system 102 maintains links to the media content at the content provider device 110. The content provider access engine 604 maintains these links.

The distribution engine 606 provides media content to the user device(s) associated with a subscriber. For example, the distribution engine 606 provides a copy of an electronic book to an offline reader device or a television program to an Internet enabled television. In various embodiments, the distribution engine 606 will obtain the formatted media content from the layout engine 602 and forward the formatted media content to the user device.

The search engine 608 allows a subscriber to search for particular media content. The media content being provided to the subscriber may be extensive. If the subscriber is only interested in one particular portion of the media content, the subscriber has an ability to search for that particular portion. For example, the subscriber may subscribe to the New York Times, but may not want to read all the media content. Instead, the subscriber may only be interested in a particular story. In this case, the subscriber can enter keywords and the search engine 608 will find one or more pieces of media content that satisfy the search. The search result may then be served by the distribution engine 606 to the subscriber.

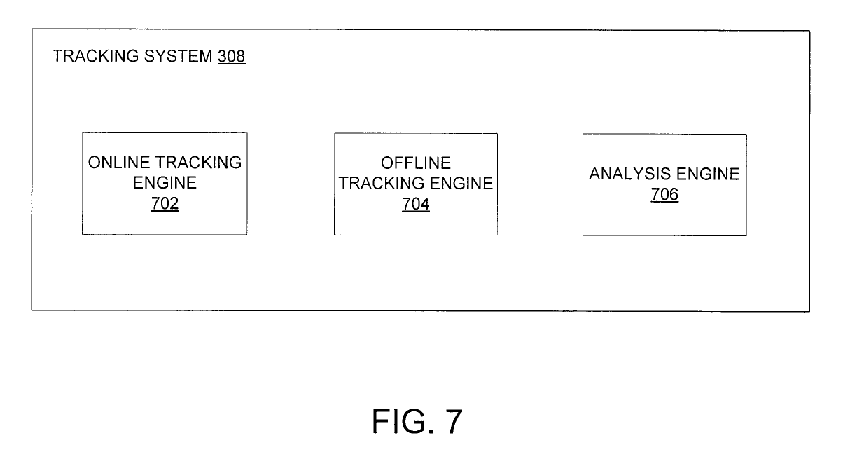

FIG. 7 is a block diagram illustrating an exemplary embodiment of a tracking system (e.g., the tracking system 308). The tracking system 308 tracks activities of subscribers with respect to the various media content. The results of the tracking system 308 may be used for determining revenue among a plurality of content providers. For example if the subscriber's media bundle includes four newspaper, revenues may be divided between the four newspaper based on subscriber's activities. In another example, the tracking data may be used to determine future revenue divisions between content providers. For example, if one particular content provider has a much higher activity rate than others, that particular content provider may be offered a larger revenue share. The tracking data may be used for other functions as well, such as, for example, ranking media content and determining pricing schemes of various subscription plans.

In exemplary embodiments, the tracking system 308 comprises an online tracking engine 702, an offline tracking engine 704, and an analysis engine 706. The online tracking engine 702 tracks online activities of subscribers. The tracking data includes click-throughs, amount of time spent on each media content, frequency of access to media content, and uniqueness of the audience (e.g., number of individual subscribers accessing the media content versus a same subscriber accessing media multiple times). Because online activities occur through the aggregate media system 102 (e.g., media content accessed via the aggregated media system 102), the online tracking engine 702 can easily track these activities. The tracking data may be stored to a database (e.g., the database 210) for later analysis.

The offline tracking engine 704 tracks offline activities of subscribers. In exemplary embodiments, a user device (e.g., user device 106) of the subscriber will track frequency (e.g., number of times media content is accesses) as well as engagement of the subscriber (e.g., amount of time spent viewing the media content). The user device caches or stores the tracking data until it is communitively coupled with the aggregated media system 102. Once coupled via the network 104, the offline tracking engine 704 obtains the tracking data and stores the tracking data to a database (e.g., the database 210) for later analysis.

The analysis engine 706 performs analysis on the online and offline tracking data. The analysis engine 706 accesses the stored tracking data and processes the tracking data for audience, frequency, and engagement metrics. Other metrics may be contemplated. The audience metric considers the uniqueness of the individuals accessing the media content. The frequency metric considers a number of times each media content is accessed. The engagement metric considers a length of time subscribers spend viewing each media content. The engagement metric may also track level of interaction with the media content. In some embodiments, two or more of these metrics are aggregated into a final tracking metric that may be outputted for various uses.

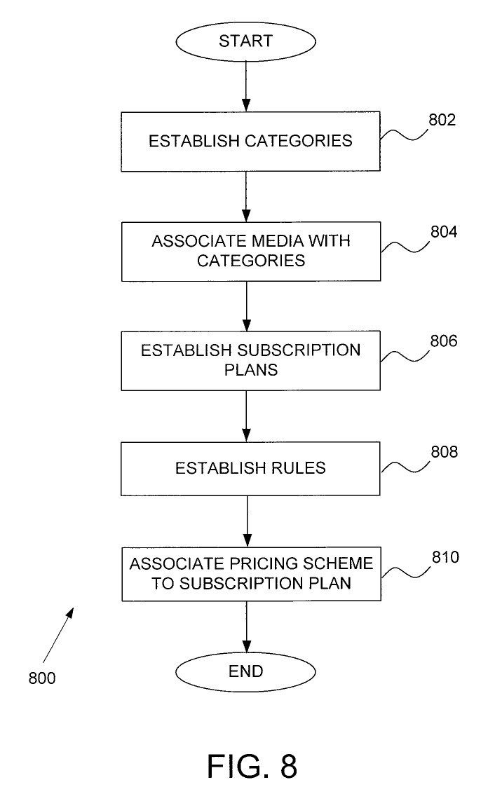

FIG. 8 is a flowchart illustrating an exemplary method 800 for establishing subscription plans. The aggregated media system 102 generates a number of different subscription plans to offer to subscribers. In operation 802, content categories are established. Content categories include, for example, newspapers, magazines, journals, television series, television programs (e.g., a single instance of a show or a one-time event), online newspapers, online magazines, and online video series. The content categories are further divided into global, national, regional, and local categories. Other category and subcategory schemes may be utilized.

At operation 804, media and media components (e.g., a single article, section, or episode of a media) are categorized into one or more of the established content categories. Each media or media component may be categorized under multiple content categories. For example, The New York Times may be categorized as a national, regional (e.g., to the East Coast), and local (e.g., to New York) newspaper, while an online version of The New York Times may be categorized as a national, regional, and local online newspaper. Furthermore, sections of the New York Times may be categorized as well. For example, a sports section of the New York Times may be categorized under a sports category, a local sports category, a regional sports category, and a national sports category.

Subscription plans are generated at operation 806. Each subscription plan comprises a number of media a subscriber is allowed to subscriber to and content categories from which these media may be selected. For example, a sports subscription plan may allow a subscriber to subscribe to three sports magazines, two sports sections from newspapers, and two television programs from one sports channel.

Rules are established at operation 808 for each subscription plan. These rules ensure that a subscriber confirms to requirements associated with a selected subscription plan when establishing their customized media bundle. For the sports subscription plan example, the rules ensure that a subscriber's selection of media includes three sports magazines, two sports sections from newspapers, and two television programs from one sports channel. If the selection does not conform with these rules, then an error message is sent to the subscriber, and the subscriber will have to adjust their selection until a conforming set of media is selected.

A pricing scheme is associated with each subscription plan at operation 810. The pricing scheme may be based on factors such as, for example, popularity of the subscription plan, types of media content available via the subscription plan, and content providers associated with media categories in the subscription plan. Tracking metrics may also be taken into consideration when determining pricing for each subscription plan.

While the method 800 of FIG. 8 pre-establishes subscription plans, alternative embodiments may generate a subscription plan based on user preferences. For example, the subscriber may desire to subscribe to two sports magazines and a sports channel. If this subscription plan does not already exist, the plans module (e.g., the plans module 408) may generate a subscription plan that matches the subscriber's desires (e.g., determine a subscription price and establish the subscription plan).

FIG. 9 is a flowchart illustrating an exemplary method 900 for generating a media subscription bundle. The media subscription bundle is customized for each subscriber based on the subscriber's selection of media. In operation 902, a list of available subscription plans is provided to a subscriber. In some embodiments, the list may be refined based on user preferences. For example, if the subscriber is interested in a subscription plan that is directed to travel, then a listing of travel related subscription plans is provided to the subscriber.

A selection of a subscription plan is received from the subscriber at operation 904. In exemplary embodiments, the subscriber selects a subscription plan from the list provided in operation 902. The subscriber may highlight, check a box, or otherwise indicate the subscription plan that the subscriber wants to accept.

Content categories and rules associated with the selected subscription plan are determined in operation 906. In exemplary embodiments, the aggregated media system determines the content categories of the subscription plan and provides a listing of the media and media components in the content categories at operation 908.

At operation 910, a selection of media and media components is received from the subscriber. The subscriber may highlight, check a box, or otherwise indicate the media or media components to which the subscriber desires to subscribe. A determination is made at operation 912 as to whether the selected media and media components abide by the rules of the subscription plan. For example, a basic subscription plan allows a selection of media including one national newspaper, three local newspapers, one sports magazine, and one men's interest magazine. If the selection received in operation 910 does not conform with these rules at operation 912, then an error message is sent to the subscriber at operation 914. The subscriber will have to adjust their selection until a conforming set of media is selected. Alternatively, the subscriber may be asked if they want to change their subscription.

If the selection does conform with the rules at operation 912, then the media bundle is generated for the subscriber and the details of the subscription are associated with the subscriber's account at operation 916. As a result, the subscriber will be allowed to subsequently access the subscribed-to media for a period of time stipulated by the subscription plan.

It is appreciated that the methods of FIG. 8-FIG. 9 are exemplary. Alternative embodiments may comprise more, less, or functionally equivalent steps. For example, operations 806 and 808 may be combined into a single operation. Furthermore, the steps of the various methods may be practiced in a different order. For example, the method 800 may establish categories (operation 802), establish subscription plans (operation 806), and establish rules (operation 808) prior to associating media with the categories (operation 804).

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

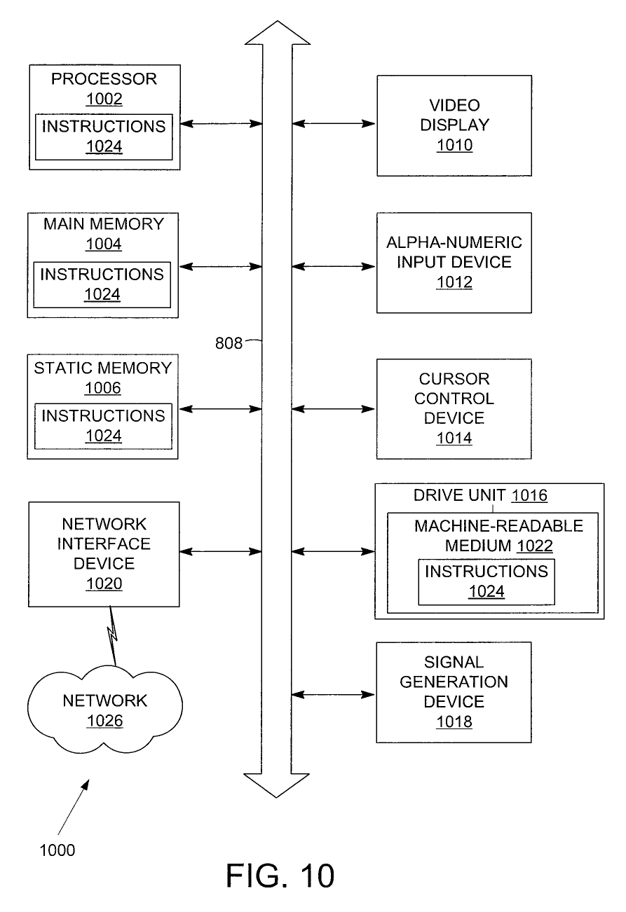

With reference to FIG. 10, an exemplary embodiment extends to a machine in the exemplary form of a computer system 1000 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 may include a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT) or future display technologies such as OLEDs, etc.). In exemplary embodiments, the computer system 1000 also includes one or more of an alpha-numeric input device 1012 (e.g., a keyboard), a user interface (UI) navigation device or cursor control device 1014 (e.g., a mouse or touch sensitive screen), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media.

While the machine-readable medium 1022 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium via the network interface device 1020 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method for providing rule-based media subscription bundles, the method comprising:
receiving a selection of a subscription plan from a subscriber;
determining one or more content categories and rules associated with the selected subscription plan, the rules comprising a designation of a number of selections of media to be made from the one or more content categories;
providing a listing of media associated with the one or more content categories;
receiving a selection of media from the listing of media; and
generating the media subscription bundle comprising the selected media.

2. The method of claim 1, further comprising determining whether the selected media abide by the rules associated with the selected subscription plan, and generating an error message when the selected media do not abide by the rules.

3. The method of claim 1, further comprising integrating one or more promotions associated with the selected media into the selected subscription plan.

4. The method of claim 1, further comprising establishing the content categories.

5. The method of claim 1, further comprising associating media with the content categories.

6. The method of claim 1, further comprising establishing subscription plans based on content categories and rules.

7. The method of claim 1, wherein the selected subscription plan is subject matter specific.

8. The method of claim 1, wherein the listing of media comprises a combination of online and offline media.

9. The method of claim 1, wherein the listing of media comprises an article or section of a print media.

10. The method of claim 1, wherein the listing of media comprises a single episode or particular program of a video media.

11. The method of claim 1, further comprising allowing access of selected media via both a content provider system and an aggregated media system.

12. A system for providing rule-based media subscription bundles, the system comprising:
a plans module to receive a selection of a subscription plan from a subscriber and to determine one or more content categories and rules associated with the selected subscription plan, the rules comprising a designation of a number of selections of media to be made from the one or more content categories;
a categories module to provide a listing of media associated with the one or more content categories; and
a bundle module to generate the media subscription bundle comprising a selection of media.

13. The system of claim 12, further comprising a rules module to determine if a selection of media abides by the rules of the selected subscription plan.

14. The system of claim 12, further comprising a promotions module to integrate one or more promotions into the selected subscription plan.

15. The system of claim 12, further comprising a content provider access engine to allow access of selected media via both a content provider system and an aggregated media system.

16. A machine-readable storage medium in communication with at least one processor, the machine-readable storage medium storing instructions which, when executed by the at least one processor, provides a method for providing rule-based media subscription bundles, the method comprising:
receiving a selection of a subscription plan from a subscriber;
determining one or more content categories and rules associated with the selected subscription plan, the rules comprising a designation of a number of selections of media to be made from the one or more content categories;
providing a listing of media associated with the one or more content categories;
receiving a selection of media from the listing of media; and
generating the media subscription bundle comprising the selected media.

17. The machine-readable storage medium of claim 16, wherein the method further comprises determining if the selected media abide by the rules associated with the selected subscription plan, and generating an error message when the selected media do not abide by the rules.

18. The machine-readable storage medium of claim 16, wherein the method further comprises integrating one or more promotions associated with the selected media into the selected subscription plan.

19. The machine-readable storage medium of claim 16, wherein the method further comprises allowing access of selected media via both a content provider system and an aggregated media system.

20. A system for providing rule-based media subscription bundles, the system comprising:
means for receiving a selection of a subscription plan from a subscriber;
means for determining one or more content categories and rules associated with the selected subscription plan, the rules comprising a designation of a number of selections of media to be made from the one or more content categories;
means for providing a listing of media associated with the one or more content categories;
means for receiving a selection of media from the listing of media; and
means for generating the media subscription bundle comprising the selected media.
